(19) United States
(12) Patent Application Publication
(10) Pub. No.: US 2024/0427492 A1
(43) Pub. Date: Dec. 26, 2024

(54) SYSTEMS AND METHODS FOR IMPROVED DATA ACCESS IN A DISTRIBUTED DATA STORAGE SYSTEM

(71) Applicant: Stripe, Inc., South San Francisco, CA (US)

(72) Inventors: Hemal Shah, Sunnyvale, CA (US); Shashi Madappa, Campbell, CA (US); Karan Vohra, Sammamish, WA (US)

(21) Appl. No.: 18/214,208

(22) Filed: Jun. 26, 2023

(51) Int. Cl. G06F 3/06; G06F 12/0813

(52) U.S. Cl. CPC G06F 3/0611; G06F 3/0635; G06F 3/067; G06F 12/0813

(57) ABSTRACT

A method and apparatus for executing data access requests in a distributed storage system are described. The method can include initiating, by a service application executing on a first computing node, a data access request to manage service data using a plurality of distributed data storage nodes that store service data for the service. The method also includes communicating, by the service application to a router application executing on the first computing node, the data access request, and determining, by the router application, at least one data storage node from the plurality of distributed data storage nodes that can satisfy the data access request. The method also includes transmitting, by the router application to at least one data storage node, the data access request for fulfillment of the data access request on behalf of the service application.

### BACKGROUND

Service provider systems provide various services to user systems over computing networks. The services provided can include commercial transaction processing services, media access services, customer relationship management services, data management services, medical services, etc., as well as a combination of such services. Modern computing techniques employed by many service provider systems typically involve deploying the functions of the service provider systems as distributed services. That is, each service may be responsible for a discreet set of functions, and the services and associated functions operate autonomously or in conjunction with one another as a whole to provide the overall functionality of a service provider system. By dividing the overall functionality of service provider systems in this way, the services may be distributed to different computing systems, multiple instances of the same services used concurrently, etc. to adapt to system load, network connectivity issues, instances of services going down, as well as other technical challenges with implementing distributed service provider systems.

In each of the above service provider systems, users of a service provider system will typically interact with the service provider system via transactions. For example, a user may make a transaction request for one of many types of transactions supported by the service provider system. Then, the one or more of the services of the distributed service provider system will perform functions of the service provider system to implement the originally requested transaction of the user. For example, the transaction may be a financial processing transaction, a media access transaction, a telecommunications transaction, etc., and one or more services of the service provider system are invoked to process a user's requested transaction.

During each of the operations performed by the service provider system during performance of a transaction, the services of the service provider system may generate and store, or seek to access stored, data associated with the service, the transaction, or other data. The data may include data associated with transaction bookkeeping purposes, record keeping purposes, regulatory requirements, end user data, service system data, third party system data, as well as other data that may be generated or accessed during the overall processing of the transaction. The service provider systems may perform millions, billions, or more transactions per hour, day, week, etc., resulting in an enormous scale of data generation and access operations of the services of the service provider system.

To efficiently perform transactions by the services of the service provider system, many technical challenges arise. For example, distributed services provider systems typically employ distributed storage techniques for storing the enormous amounts of data generated and accessed during transactions. The services of the service provider system will typically originate a data access request, and transmit the request over a communications network to a router. The router will then determine how and where to service the request at one of a plurality of distributed storage locations, and further transmit the request to the target data storage system storing a subset of data thereon. Thus, there are multiple communications that occur for each individual data access request. At a scale of millions, billions, or more data access requests per hour, day, week, etc., a significant amount of network bandwidth is consumed by such a distributed storage system. Furthermore, each communication of the request introduces a potential failure point for the data access request in that messages may be dropped, rejected, etc. at each leg of a message's journey from the message originator to the target distributed storage location. As such, there is a chance that the data access request will fail, resulting in a data access system with suboptimal reliability that can negatively impact end-user perception of the service provider system. As a result, many technical challenges are presented for enabling the processing of data access requests in a distributed storage system in a fast, efficient, and reliable manner.

### BRIEF DESCRIPTION OF THE DRAWINGS

The present disclosure will be understood more fully from the detailed description given below and from the accompanying drawings of various embodiments, which, however, should not be taken to limit the embodiments described and illustrated herein, but are for explanation and understanding only.

FIG. 1 is a block diagram of an exemplary system architecture for a service provider system that improves data access efficiency and reliability to distributed data storage.

FIG. 2 is a block diagram of one embodiment of a service provider system architecture with a service and a router implemented in the same node for improving data access efficiency and reliability to distributed data cache nodes.

FIG. 3 is a block diagram of one embodiment of a service provider system architecture with containers of a service pod interacting with containers of a router pod to provide data access to distributed data cache nodes.

FIG. 4 is a flow diagram of one embodiment of a process for executing a data access request with a service application and a router application executing on a same computing node.

FIG. 5 is a flow diagram of another embodiment of a process for executing a data access request with a service application and a router application executing within pods on a same computing node.

FIGS. 6 is one embodiment of a computer system that may be

used to support the systems and operations discussed herein.

### DETAILED DESCRIPTION

In the following description, numerous details are set forth. It will be apparent, however, to one of ordinary skill in the art having the benefit of this disclosure, that the embodiments described herein may be practiced without these specific details. In some instances, well-known structures and devices are shown in block diagram form, rather than in detail, in order to avoid obscuring the embodiments described herein.

Some portions of the detailed description that follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “initiating”, “communicating”, “determining”, “transmitting”, “initiating”, “loading”, “storing”, “accessing”, “processing”, or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

The embodiments discussed herein may also relate to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general-purpose systems may be used with programs in accordance with the teachings herein, or it may prove convenient to construct a more specialized apparatus to perform the required method steps. The required structure for a variety of these systems will appear from the description below. In addition, the embodiments discussed herein are not described with reference to any particular programming language. It will be appreciated that a variety of programming languages may be used to implement the teachings as described herein.

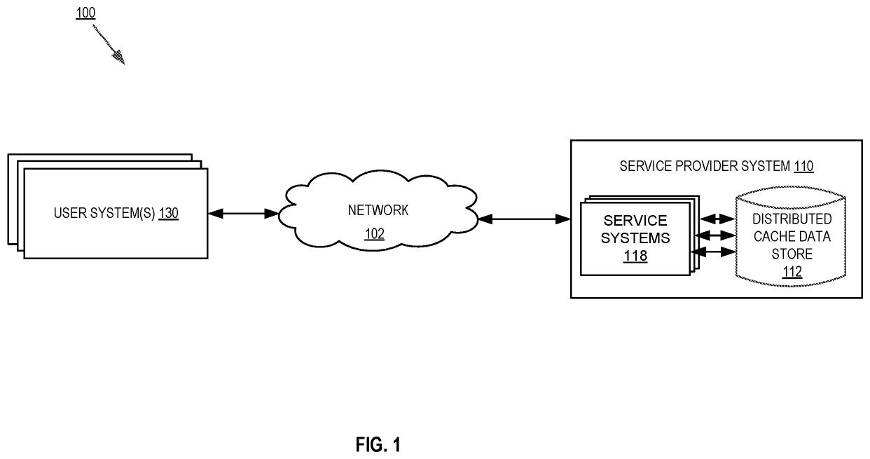

FIG. 1 is a block diagram of an exemplary system architecture 100 for a service provider system that improves data access efficiency and reliability to distributed data storage. In one embodiment, the system architecture 100 includes service provider system 110 and one or more end user system(s) 130. In one embodiment, one or more of the end user system(s) may be mobile computing devices, such as a smartphone, tablet computer, smartwatch, etc., as well computer systems, such as a desktop computer system, laptop computer system, server computer systems, etc. The service provider system 110 and one or more of the end user system(s) 130 may also be one or more computing devices, such as one or more server computer systems, desktop computer systems, etc.

The embodiments discussed herein may be utilized by a plurality of different types of service provider systems, such as commerce platform systems including payment processing systems, card authorization systems, banks, and other systems seeking to perform zero downtime topology updates of distributed data stores, as discussed in greater detail below. Furthermore, any system seeking to store data in a distributed fashion, such as medical information systems, customer relationship management systems, media storage and distribution systems, etc. may use and/or extend the techniques discussed herein to improve the efficiency and reliability of data access request processing in distributed storage systems. However, to avoid obscuring the embodiments discussed herein, the operations and techniques to improve the efficiency and reliability of data access request processing in distributed storage systems may use examples of a commerce platform service provider system to illustrate and describe the embodiments of the present invention, and are not intended to limit the application of the operations and techniques described herein from applicability to other systems.

The service provider system 110 and end user system(s) 130 may be coupled to a network 102 and communicate with one another using any of the standard protocols for the exchange of information, including secure communication protocols. In one embodiment, one or more of the service provider system 110 and end user system(s) 130 may run on one Local Area Network (LAN) and may be incorporated into the same physical or logical system, or different physical or logical systems. Alternatively, the service provider system 110 and end user system(s) 130 may reside on different LANs, wide area networks, cellular telephone networks, etc. that may be coupled together via the Internet but separated by firewalls, routers, and/or other network devices. In one embodiment, service provider system 110 may reside on a single server, or be distributed among different servers, coupled to other devices via a public network (e.g., the Internet) or a private network (e.g., LAN). It should be noted that various other network configurations can be used including, for example, hosted configurations, distributed configurations, centralized configurations, etc.

In one embodiment, service provider system 110 provides financial processing services to one or more merchants, such as end user system(s) 130. For example, service provider system 110 may manage merchant accounts held at the commerce platform, run financial transactions initiated at end user system(s) 130, clear transactions, performing payouts to merchant and/or merchant agents, manage merchant and/or agent accounts held at the service provider system 110, as well as other services typically associated with commerce platforms systems such as, for example, STRIPE™. Each of these functions may be carried out by one or more service system(s) 118 of the service provider system 110. That is, service provider system 110 divides the services it provides to end user among one or more service systems(s) 118 so that the processing of the services may be distributed. Such distribution of service processing enables service provider systems to scale based on load, demand, hardware issues, geographic needs, expanded service offerings, as well as for other reasons.

In embodiments, end user system(s) 130 access the services of service provider system 110 by network based messaging, such as application programming interface (API) based messaging where remote calls of end user system(s) 130 request a service by messaging the request to one or more of the service systems 118. The service systems 118 in turn, and in order to execute the requested service, may generate messages to other service systems 118, generate data associated with the requested service that is stored in distributed cache data store 112, access data stored in distributed cache data store(s) 112 that is needed to process the requested service, or a combination of such operations. Thus, each requested service operation generates, stores, accesses, write, deletes, modified, or otherwise interacts with data stored at the distributed cache data store 112. Furthermore, such data may originate from the end user system(s) 130 (e.g., user supplied data) and/or may be data associated with a requested service that is generated by a service system 118 (e.g., service generated/supplied data).

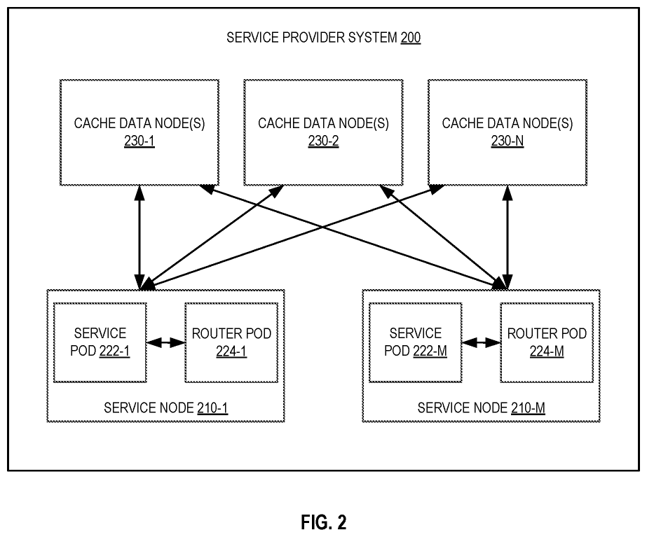

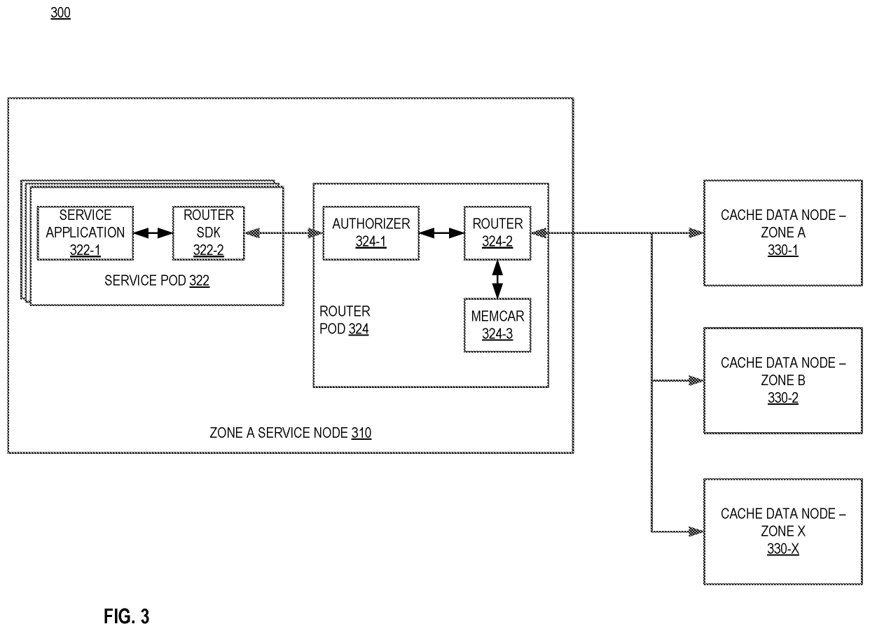

Service provider system 110 provides numerous services to end user systems(s) 130. For example, where service provider system is a commerce platform, the services may include running financial transactions for merchant end users, managing agent accounts of merchants, performing tax accounting services as a result of the various financial transactions, performing data control and management of merchant data, providing platform hosting services, as well as any other such services. Each of these services may be initiated at the request of an end user system 130, by another service 118, or a combination thereof. Furthermore, end user system(s) 130 may include a plurality of end user systems(s) that as a whole invoke the services of service system(s) 118 on the scale of millions, hundreds of millions, billions, or more service transactions per hour, day, etc. Therefore, the number of data access requests generated by the service systems(s) 118 is very large, and the number of communications between the service systems 118 and the distributed cache data store 112 is also very large. As a result, the messaging used to execute the data access requests is susceptible to consuming a vast amount of network bandwidth, and is further susceptible to potential lack of reliability. Because of this scale, in embodiments, service provider system 110 employs an architecture where a service that provides one of the services 118 and a router that enables routing of the data access requests to an appropriate node in the distributed cache data store 112 are executed within the same physical machine (e.g. node). This architecture is discussed more fully in FIGS. 2 and 3.

In embodiments, distributed cache data store 112 is cache memory of a distributed data storage system, such as a Memento™ data storage system. The distributed cache data store 112 is a cache storage where data accesses (e.g., data being generated and stored, read, overwritten, edited, copied, moved, etc.) are processed from the machines/nodes that make up the distributed cache data store 112. In some embodiments, the distributed cache is a pool of random access memory (RAM) of multiple physical resources (e.g., computing systems that implement the service systems 118) that serves as an in-memory data store to provide fast access to the data stored within the distributed cache data store(s) 112. For systems, such as service provider system 110 that operates at scale, the use of distributed cache data store(s) 112 to manage data accessed by the service systems 118 is therefore both beneficial to end user system(s) 130 and service systems 118 as data access requests may be handled more quickly and use less network bandwidth.

As will be discussed in greater detail below, the volume of data access requests is susceptible to consuming a vast amount of network bandwidth as thousands, millions, billions, etc. data access request messages are transmitted to the distributed cache data store 112 each minute, hour, data, etc. Furthermore, because the data access requests are handled by the distributed cache data store 112 which may be remote to the service system 118 originating the request, the more communications that are needed to send a data access request from a service system 118 to a data storage node of the distributed cache data store 112, the more susceptible the data access request is to failure. For example, each hop that the data access message makes between different machines int eh service provider system 110, the more chance there is of network congestion, network failure, dropped packets, etc. that will cause the data access request to fail, which increases the unreliability of the distributed cache data store 112 and thus the services of the service provider system 110. The architecture discussed below, where the service that originates a data access request, and the router that enables routing of the requests to the appropriate node in the distributed cache data store 112, are executed within the same physical machine, drastically reduces network bandwidth consumption while at the same time increasing reliability in the communication and processing of data access requests. Additional technical benefits and advantages of the architecture of the present application will also become apparent in the discussion below.

FIG. 2 is a block diagram of one embodiment of a service provider system architecture 200 with services and routers implemented in the same node for improving data access efficiency and reliability to distributed data cache nodes. Service provider system 200 provides additional details for the service provider system 110 discussed above in FIG. 1.

In one embodiment, service provider system 200 includes a plurality of services and routers each executed within respective service nodes, such as service nodes 210-1 through 210-M. Each service node 210 is a physical machine, or virtual machine executed by a physical machine, having its own computing system hardware, such as one or more processors, memories, network interfaces, and other hardware typically associated with network enabled computing devices. In an embodiment, each service node 210 includes at least one service pod (e.g., service pod 221-1 in node 210-1 through service pod 221-M in node 210-M) and at least one router pod (e.g., router pod 224-1 in node 210-1 through router pod 224-M in node 210-M). Each service pod includes one or more containers that each host an application, discussed more fully in FIG. 3, that enable service data access request processing and data access request routing to be carried out within the respective service node. The service and router applications within the pods, in embodiments, are performed by processing logic that may comprise hardware (circuitry, dedicated logic, etc.), software (such as is run on a general purpose computer system or a dedicated machine), firmware, or a combination. In embodiments, the pods discussed herein may be Kubernetes™ pods, and the pods and containers encapsulating the application therein are replicatable to pods on other virtual machines and/or nodes enabling scaling of the architecture herein to meet current processing needs, redundancy needs, geographical distribution needs, etc.

The cache data nodes 230-1, 230-2, through 230-N are nodes of in-memory RAM of the physical resources used to implement the services, routers, etc. of a service provider system, and are part of one or more computing centers (e.g., web services computing systems, cloud computing systems, etc., such as AMAZON WEB SERVICES™, GOOGLE CLOUD™, IBM CLOUD™, MICROSOFT AZURE™, etc.) at which the services and routers are implemented, etc. Furthermore, in embodiments, the cache data nodes 230 may further include logic to respond to and execute data access requests, for example carrying out data access operation and replying to the services originating the requests.

As illustrated in FIG. 2, a service pod is within the same service node as a router pod. Thus, any data access request generated by a service application within a service pod may be sent to a router application within the router pod of the same service node. This means that the data access request is processed within the same machine (e.g., in-memory request handling), and the request is not transmitted over a network. Typically, different machines host service processing applications, router applications, and cache data node applications. Thus, a data access request would typically incur the latency of three network hops, and each such hop introduces a potential point of messaging failure. As discussed herein, at scale, this results in a significant number of network hops incurred by the data access request messaging, which consumes a vast amount of network bandwidth and introduces a vast number of potential failure points in the processing of the data access requests. In embodiments, as illustrated in FIGS. 2 and 3, the architecture of the service provider system 200 includes the service application (e.g., providing a service of the service provider system 200) and the router application (e.g., providing routing of data access request messages to an appropriate cache data node 230) within respective pods on the same node (e.g., service pod 222-1 and router pod 224-1 on node 210-1). Beneficially, any data access request generated by the service application within service pod 222-1 is sent directly (e.g., within a single system as a call to a local host) to the router application within the router pod 224-1, which eliminates a network hop in the routing of a data access request. The router application within the router pod 224-1 then routes the data access request to the appropriate remote cache data node, which reduces the overall number of network hops by half. Thus, the embodiments discussed herein can reduce bandwidth consumption by up to 50 percent, and also reduce potential network communication failure points by 50 percent. As a result, the presently discussed architecture and data access routing techniques significantly reduce bandwidth consumption while at the same time significantly increase reliability. Additionally, by reducing the number of network hops, data access latency is also significantly reduced, thereby improving the speed and efficiency by which data accesses are processed in a distributed storage system. As discussed herein, in modern distributed service provider systems that process hundreds of thousands, millions, billings of data access requests per minute, hour, day, etc., the resulting efficiency, reliability, and latency improvements greatly improve the data access architecture and data access processes carried out within the architecture.

FIG. 3 is a block diagram of one embodiment of a service provider system architecture 300 with containers of a service pod interacting with containers of a router pod to provide data access to distributed data cache nodes. Architecture 300 provide additional details of the architecture of the service provider system 200 discussed above in FIG. 2.

In embodiments, service nodes and cache nodes are implemented at one or more web services computing systems, cloud computing systems, etc., and may be physically, logically, geographically, or otherwise distributed. Thus, the service nodes and cache data nodes may be physically implemented in different zones within a local or wide area network. Due to this distribution, as discussed herein, routing of data access requests is performed within and/or between zones as determined by routing applications.

In order to avoid obscuring the present discussion, a zone A service node 310 is illustrated, although there may be any number of service nodes within zone A, as well as in other zones (e.g., zone A through zone X).

In embodiments, service node 310 includes one or more service pods, such as service pod 322, that utilize the routing capabilities of a router pod 324. Service pod 322 includes a container that encapsulates at least one service application 322-1, and that is responsible for executing one or more functions of the service provider system 200. For example, a service application may respond to an end user request or command (not shown), a request or command of another service, a periodic and automatic job executed by the service, as well as other operations. The data access request, in embodiments, will identify the data that is the subject of the request by a data key, such as a hash of the data, portion of data, etc. The key serves to uniquely identify the data sought to be accessed. Furthermore, in embodiments, the cache nodes are implemented as key/value based storage, which enable the unique data key to identify or index the storage locations within a cache data node where the data is stored

As part of executing the function of a service, the service application 322-1 will provide a router software development kit (SDK) 322-2 with the key of the data to be accessed and the action/function to be performed on the data (e.g., read, write, overwrite, delete, etc. data). The router SDK 322-2 is an encapsulated application that provides an interface to the router pod 324 using a set of data access functions of the SDK that enable the service application 322-1 to read, write, or otherwise interact with data at a remote cache data node. The router SDK 322-2 defines one or more API function calls, such as get, post, put, delete, etc. that are used when seeking to access service data, and which use the key and requested action generated by service application 322-1. In embodiments, such function calls implemented by the router SDK 322-2 use a data access software library, such as that provided by the Memento™ distributed data storage system and embed the key, requested data operation, service application identifiers, user or service initiating the request, user group identifiers, or other identifiers associated with the generation of the data access request message. Router SDK 322-2 then sends the data access request message to router pod 324 also within zone A service node 310. This avoids the need to contact a remote router.

Router pod 324 is also a pod of the zone A service node 310 that includes a plurality of containerized applications, including an authorizer 324-1, a router 234-2, and a memcar application 324-3. Other applications associated with a router may be used within router pod 324, but are not illustrated to avoid obscuring the embodiments discussed herein. Authorizer 324-1 is the application of the router pod 324 that receives the data access request message from SDK 322-2, including the key, requested data access operation, service/user identifier, etc. Authorizer 324-1 is responsible for performing security authentication and authorization of a data access request. That is, if service A stores data, only service A should be able to access that data. If service B requests service A data, authorizer 324-1 rejects this request to prevent unauthorized data access. Furthermore, even if service A requests service A data, authorizer 324-1 enforces authorization on particular data to authorized users or authorized user groups. In embodiments, the key supplied with the data access request is validated by authorizer 324-1. In embodiments, authorizer 324-1 maintains an access list and performs a lookup to see if the supplied key and/or other identifiers are allowed to access the requested data, perform the requested operation, etc. For example, authorizer 324-1 confirms that the service originating the request is authorized to access data identified by the key by consulting the permissions within the access list. Access lists may be securely distributed upon creation of the service pod 322 instance and/or periodically from a trusted source (e.g., authenticated and communicated over secure channel). After a data access request is determined to be authorized by authorizer 324-1, it is forwarded to router 324-2. In some embodiments, authorizer 324-1 is the single source of data access security, which eliminates the need for router 324-2, memcar 324-3, and a cache data node to perform data access authorization checks. Rather, router 324-2, memcar 324-3, and cache data nodes can safely infer authorized access by the receipt of the data access message from authorizer 324-1, as authorizer 324-1 will only forward on approved data access requests.

In embodiments, router 324-2 is a proxy application that sits between the cache nodes 330-1, 330-1, through 330-X, and the service pod 322. Router 324-2 includes routing logic, such as the Memento™ memrouter logic, that determines where data is stored amongst the cache nodes based topology files. In embodiments, memcar 324-3 is responsible for obtaining and/or generating topology files 324-3. One technique for generating and managing such topology files that can be used by memcar 324-3 is discussed more fully in U.S. Patent Application ______, entitled “SYSTEMS AND METHODS FOR ZERO DOWNTIME TOPOLOGY UPDATES FOR DISTRIBUTED DATA STORAGE”, filed on the same data as the present application.

Each topology file stores, for each service and/or end user, an ordered set of IP addresses of the cache nodes where data is stored for that service/end user. The ordered set is predefined, includes the number of cache nodes used by the service/end user, and identifies each cache node by IP address within the given ordering. With the ordered listing of IP addresses of the cache nodes and the total number of nodes, a deterministic data distribution technique, such as the jump hash technique, is able to repeatedly calculate, based on the received key and total number of nodes for a service/end user, which node in the ordered listing data to be accessed is stored at. That is, a key value and a number of nodes is input into the jump hash, which outputs a deterministic node selection (e.g., among nodes 330-1 through 330-X). For example, if there are 3 cache nodes associated with a service (e.g., the service application 322-1 within service pod 322), and a key value of 1234 is input with the total number of nodes, the jump hash technique will always return the same resulting node, such as node 2 for the combination of key and number of total cache nodes. The router 324-2 uses the computed position within a services node list to determine a specific node's IP address, and the associated storage location of the data associated with the received key. Furthermore, the jump hash technique performs regular distribution, so that data written to nodes is distributed in an even fashion.

Once router 324-2 determines the appropriate node at which the data subject to the data access request is located (e.g., based on the data key), router 324-2 transmits the data access request to the appropriate node within the appropriate zone. The cache data node then responds with and/or processes the associated data access request.

In the embodiments discussed herein, the data access request is therefore subject to the single network hop—between zone A service node 310 and the selected cache data node 330. Beneficially, the number of total hops used to initiate, route, and fulfill a data access request is reduced by half, which in turn reduces the potential for data access request message failure. Additionally, the SDK used within service pod 322 is greatly simplified as messaging is within the same machine (e.g., in-memory) and does not use network based messaging. Further still, security is improved as there can be a strict control put on data access, and requests to access data only proceed once authorized.

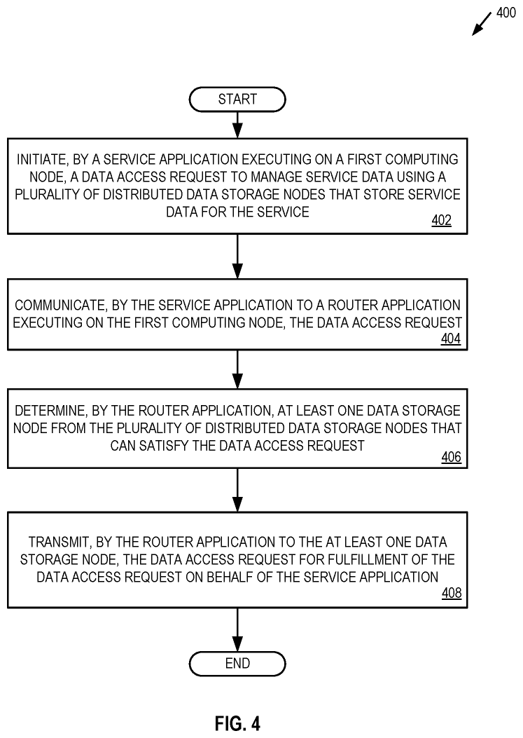

FIG. 4 is a flow diagram of one embodiment of a process 400 for executing a data access request with a service application and a router application executing on the same computing node. The process 400 is performed by processing logic that may comprise hardware (circuitry, dedicated logic, etc.), software (such as is run on a general purpose computer system or a dedicated machine), firmware, or a combination. In one embodiment, the process 400 is performed by applications of a service pod and a router pod on a single service node (e.g., pods 322 and 324 of node 310).

Referring to FIG. 4, processing logic begins by initiating, by a service application executing on a first computing node, a data access request to manage service data using a plurality of distributed data storage nodes that store service data for the service (processing block 402). As discussed herein, the service application is encapsulated within a service pod of a service node. Furthermore, in embodiments, there may be a plurality of service pods concurrently being executed by processing logic of the service node. The service application receives the request responsive to a user request, the request is initiated by the service application, or the request is initiated by another service application. Furthermore, the data access request is generated to include a key of the data that is the subject of the request, as well as one or more identifiers of the user, service, user group, etc. that initiated the request.

Processing logic then communicates, by the service application to a router application executing on the first computing node, the data access request (processing block 404). In embodiments, a router SDK is used to generate a message containing the data access request, including the key and one or more identifiers that define what user and/or entity initiated the request. The router SDK, in embodiments, is a Memento™ router SDK that includes functions for accessing the services of a router application. In embodiments, the communication is to a local pod (e.g., a router pod) within the same system executing the service pod.

Processing logic determines, by the router application, at least one data storage node from the plurality of distributed data storage nodes that can satisfy the data access request (processing block 406). As discussed herein, processing logic uses a deterministic technique, such as the jump hash technique, to determine from among a set of distributed cache data nodes associated with a service's data, which specific cache data node contains the data associated with the key. Furthermore, a single router application encapsulated in a router pod may support multiple service pods executing within the same service node.

Once the storage location is determined for the data associated with the request, processing logic transmits, by the router application to the at least one data storage node, the data access request for fulfillment of the data access request on behalf of the service application (processing block 408). In embodiments, the at least one data storage node is a cache data storage node that is remote to the service node, the router transmits the data access request over communications network to the service node.

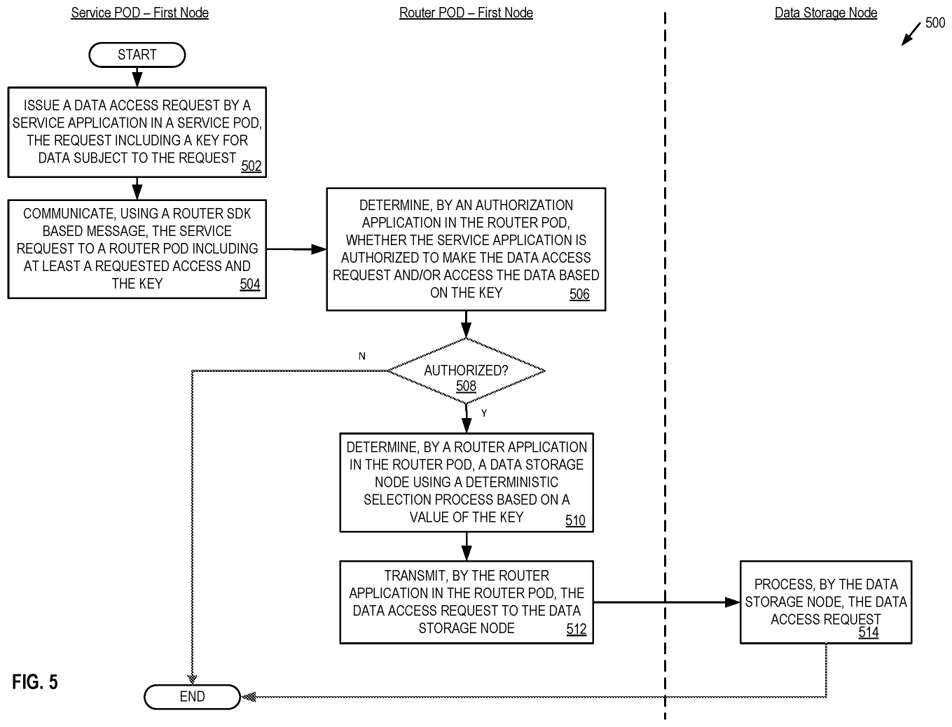

FIG. 5 is a flow diagram of another embodiment of a process 500 for executing a data access request with a service application and a router application executing within pods on the same computing node. The process 500 is performed by processing logic that may comprise hardware (circuitry, dedicated logic, etc.), software (such as is run on a general purpose computer system or a dedicated machine), firmware, or a combination. In one embodiment, the process 500 is performed by applications of a service pod and a router pod on a single service node (e.g., pods 322 and 324 of node 310).

Referring to FIG. 5, processing logic of a first node begins by Issuing a data access request by a service application in a service POD, where the request includes at least a key for data subject to the request (processing block 502). The key may be derived from the data subject to the request, such as by hashing the data, a portion of the data, a portion of the data combined with additional data (e.g., a salt), etc. The key serves as an identifier, index, etc. of the data subject to the data access request, and as discussed herein is used to determine how to route data access requests. In embodiments, as discussed herein, additional data may also be included in the request, as well as the requested data access operation (e.g., access stored data, write data, overwrite data, delete data, move data, replicate data, etc.).

Processing logic then communicates, using a router SDK based message, the service request to a router POD including at least a requested access and the key (processing block 504). The router SDK, as discussed herein, is a set of router messaging functions that enables the service to issue data access requests in way that interpretable by a router application. For example, the SDK formats the message, generates a message payload, and uses appropriate functions to communicate the message to a router application. Furthermore, the message is communicated between local hosts of the first node as the service pod and the router pod are executed by the same physical computing device or virtualized computing device.

Processing logic determines, by an authorization application in the router POD, whether the service application is authorized to make the data access request and/or access the data based on the key (processing block 506). In embodiments, the authorization application is encapsulated in a container of the router pod at the first node. Furthermore, as discussed herein, the authorization application accesses an authorization listing indicating which data is accessible to which service, user, user group, etc. The authorization application receives this authorization listing in a secure fashion, such as over encrypted communications channels, from a trusted source. Furthermore, the authorization listing may be periodically refreshed to capture a current state of access authorization.

Based on the supplied key, processing logic determines whether the data access request is authorized (processing block 508). When the data access request is not authorized, such as when a service, user, user group, etc. seeks to access data that they are not authorized to access, the request fails and the process ends. In some, embodiments, an error code, message, etc. is returned to the original requesting service application to indicate that the requested data access is not authorized, and may include one or more reasons why authorization failed (e.g., service not authorized, operation not authorized, etc.).

However, when the data access request is determined to be authorized (processing block 508), processing logic then determines, by a router application in the router pod, a data storage node using a deterministic selection process based on a value of the key (processing block 510). The router application, as discussed herein, determines based on the key and cached data nodes associated with a requesting service/user/user group which cache data node from a set of nodes the data associated with the key is located at. For example, processing logic may use the jump hash technique as a deterministic node selection technique using the key as an input to a jump hash process that generates an index as to which data storage node a data access request is to be routed to. Once the appropriate node is selected, processing logic utilizes a distributed routing logic of the Memento™ memrouter to generate a network based memory access message directed to the selected remote cache data node.

Processing logic transmits, by the router application in the router pod, the data access request to the data storage node (processing block 512). The transmission includes the sending of the message over a communications network. In some embodiments, the message may be encrypted prior to transmission to secure the message contents.

Processing logic then processes, by the data storage node, the data access request (processing block 514). The data storage node is remote to the first node, and thus receives the network-based message. Furthermore, since the first node performed an authorization of the data access request, the data storage node infers the authorization of the request and does not re-perform message authorization. Instead, the data storage node is able to rely on the prior authorization performed by the authorization application of the first node.

In embodiments, the communication between blocks 504 and 506 involves communication between local hosts of the same node (e.g., the first node). The communication between the router application and the data node, however, is a network-based communication. However, the data access request and routing does not involve a network hop, and only the message to the data node involves a network hop. As a result, the bandwidth consumed by the messaging of a data access request and fulfillment is reduced by half, greatly preserving bandwidth of a distributed storage system. Furthermore, by reducing the number of network hops of each data access request from start to fulfillment, the potential points of messaging failure is greatly reduced. Additionally, by reducing the number of network hops in data access operations, latency is reduced resulting in a data access system that is able to perform data access in a reduced amount of time. The result, therefore, is a more efficient architecture of distributed data storage, and one with increased reliability.

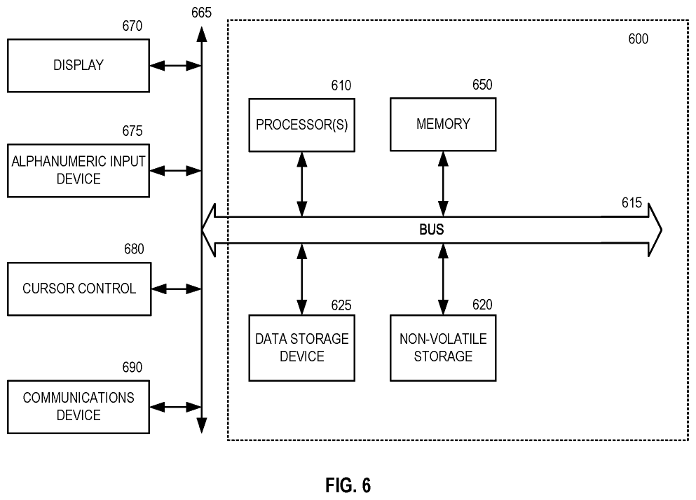

FIG. 6 is one embodiment of a computer system that may be used to support the systems and operations discussed herein. For example, the computer system illustrated in FIG. 6 may be used by a commerce platform system, a merchant development system, merchant user system, etc. It will be apparent to those of ordinary skill in the art, however that other alternative systems of various system architectures may also be used.

The data processing system illustrated in FIG. 6 includes a bus or other internal communication means 615 for communicating information, and a processor 610 coupled to the bus 615 for processing information. The system further comprises a random access memory (RAM) or other volatile storage device 650 (referred to as memory), coupled to bus 615 for storing information and instructions to be executed by processor 610. Main memory 650 also may be used for storing temporary variables or other intermediate information during execution of instructions by processor 610. The system also comprises a read only memory (ROM) and/or static storage device 620 coupled to bus 615 for storing static information and instructions for processor 610, and a data storage device 625 such as a magnetic disk or optical disk and its corresponding disk drive. Data storage device 625 is coupled to bus 615 for storing information and instructions.

The system may further be coupled to a display device 670, such as a light emitting diode (LED) display or a liquid crystal display (LCD) coupled to bus 615 through bus 665 for displaying information to a computer user. An alphanumeric input device 675, including alphanumeric and other keys, may also be coupled to bus 615 through bus 665 for communicating information and command selections to processor 610. An additional user input device is cursor control device 680, such as a touchpad, mouse, a trackball, stylus, or cursor direction keys coupled to bus 615 through bus 665 for communicating direction information and command selections to processor 610, and for controlling cursor movement on display device 670.

Another device, which may optionally be coupled to computer system 600, is a communication device 690 for accessing other nodes of a distributed system via a network. The communication device 690 may include any of a number of commercially available networking peripheral devices such as those used for coupling to an Ethernet, token ring, Internet, or wide area network. The communication device 690 may further be a null-modem connection, or any other mechanism that provides connectivity between the computer system 600 and the outside world. Note that any or all of the components of this system illustrated in FIG. 6 and associated hardware may be used in various embodiments as discussed herein.

It will be appreciated by those of ordinary skill in the art that any configuration of the system may be used for various purposes according to the particular implementation. The control logic or software implementing the described embodiments can be stored in main memory 650, mass storage device 625, or other storage medium locally or remotely accessible to processor 610.

It will be apparent to those of ordinary skill in the art that the system, method, and process described herein can be implemented as software stored in main memory 650 or read only memory 620 and executed by processor 610. This control logic or software may also be resident on an article of manufacture comprising a computer readable medium having computer readable program code embodied therein and being readable by the mass storage device 625 and for causing the processor 610 to operate in accordance with the methods and teachings herein.

The embodiments discussed herein may also be embodied in a handheld or portable device containing a subset of the computer hardware components described above. For example, the handheld device may be configured to contain only the bus 615, the processor 610, and memory 650 and/or 625. The handheld device may also be configured to include a set of buttons or input signaling components with which a user may select from a set of available options. The handheld device may also be configured to include an output apparatus such as a liquid crystal display (LCD) or display element matrix for displaying information to a user of the handheld device. Conventional methods may be used to implement such a handheld device. The implementation of embodiments for such a device would be apparent to one of ordinary skill in the art given the disclosure as provided herein.

The embodiments discussed herein may also be embodied in a special purpose appliance including a subset of the computer hardware components described above. For example, the appliance may include a processor 610, a data storage device 625, a bus 615, and memory 650, and only rudimentary communications mechanisms, such as a small touch-screen that permits the user to communicate in a basic manner with the device. In general, the more special-purpose the device is, the fewer of the elements need be present for the device to function.

It is to be understood that the above description is intended to be illustrative, and not restrictive. Many other embodiments will be apparent to those of skill in the art upon reading and understanding the above description. The scope should, therefore, be determined with reference to the appended claims, along with the full scope of equivalents to which such claims are entitled.

The foregoing description, for purpose of explanation, has been described with reference to specific embodiments. However, the illustrative discussions above are not intended to be exhaustive or to limit the described embodiments to the precise forms disclosed. Many modifications and variations are possible in view of the above teachings. The embodiments were chosen and described in order to best explain the principles and practical applications of the various embodiments, to thereby enable others skilled in the art to best utilize the various embodiments with various modifications as may be suited to the particular use contemplated.

We claim:

1. A method for executing data access requests in a distributed storage system:
initiating, by a service application executing on a first computing node, a data access request to manage service data using a plurality of distributed data storage nodes that store service data for the service;
communicating, by the service application to a router application executing on the first computing node, the data access request;
determining, by the router application, at least one data storage node from the plurality of distributed data storage nodes that can satisfy the data access request; and
transmitting, by the router application to the at least one data storage node, the data access request for fulfillment of the data access request on behalf of the service application.

2. The method of claim 1, wherein the service application is executed within a service pod at the first computing node, the router application is executed within a router pod at the first computing node, and the data access request is communicated locally between the service pod and the router pod at the first computing node.

3. The method of claim 2, wherein the at least one data storage node is remote to the first computing node, and the data access request is transmitted from the router pod to the at least one data storage node over a communications network.

4. The method of claim 2, wherein the at least one data storage node is the first computing node, and the data access request is transmitted locally from the router pod to a pod comprising the at least one data storage node.

5. The method of claim 2, wherein the service application communicates the data access request to the router application at the router pod using a router software development kit (SDK) message.

6. The method of claim 2, wherein the service pod and the router pod each comprise a Kubernetes pod.

7. The method of claim 2, wherein the service pod is one of a plurality of service pods executed at the first computing node, and wherein each of the plurality of service pods issues data access requests through the router pod.

8. The method of claim 1, wherein determining, by the router application, the at least one data storage node from the plurality of distributed data storage nodes that can satisfy the data access request further comprises:
determining, by an authorizer application executed within the router pod at the first computing node, whether the service is authorized to issue the data access request based on a key corresponding to service data that is the subject of the data access request;
in response to the determining that the service is authorized, determining, by the router application, the at least one data storage node from among the plurality of distributed data storage nodes using a deterministic selection process based on the key; and
initiating transmission, by the router application to the at least one data storage node, of the data access request.

9. The method of claim 8, wherein the at least one data storage node infers the service is authorized to make the data access request for the service data based on the determination of the router application, and the at least one data storage node fulfills the data access request for the service without performing a second service authorization.

10. One or more non-transitory computer readable storage media having instructions stored thereupon which, when executed by a system having at least a processor and a memory therein, cause the system to perform operations for executing data access requests in a distributed storage system, comprising:
initiating, by a service application executing on a first computing node, a data access request to manage service data using a plurality of distributed data storage nodes that store service data for the service;
communicating, by the service application to a router application executing on the first computing node, the data access request;
determining, by the router application, at least one data storage node from the plurality of distributed data storage nodes that can satisfy the data access request; and
transmitting, by the router application to the at least one data storage node, the data access request for fulfillment of the data access request on behalf of the service application.

11. The storage media of claim 10, wherein the service application is executed within a service pod at the first computing node, the router application is executed within a router pod at the first computing node, and the data access request is communicated locally between the service pod and the router pod at the first computing node.

12. The storage media of claim 11, wherein the at least one data storage node is remote to the first computing node, and the data access request is transmitted from the router pod to the at least one data storage node over a communications network.

13. The method of claim 11, wherein the at least one data storage node is the first computing node, and the data access request is transmitted locally from the router pod to a pod comprising the at least one data storage node.

14. The storage media of claim of claim 10, wherein determining, by the router application, the at least one data storage node from the plurality of distributed data storage nodes that can satisfy the data access request further comprises:
determining, by an authorizer application executed within the router pod at the first computing node, whether the service is authorized to issue the data access request based on a key corresponding to service data that is the subject of the data access request;
in response to the determining that the service is authorized, determining, by the router application, the at least one data storage node from among the plurality of distributed data storage nodes using a deterministic selection process based on the key; and
initiating transmission, by the router application to the at least one data storage node, of the data access request.

15. The storage media of claim of claim 14, wherein the at least one data storage node infers the service is authorized to make the data access request for the service data based on the determination of the router application, and the at least one data storage node fulfills the data access request for the service without performing a second service authorization.

16. A first computer node for executing data access requests in a distributed storage system, comprising:
a memory having instructions stored thereupon; and
one or more processors coupled with the memory, configured to execute the instructions, causing the one or more processors to perform operations, comprising:
initiating, by a service application executing on the first computing node, a data access request to manage service data using a plurality of distributed data storage nodes that store service data for the service,
communicating, by the service application to a router application executing on the first computing node, the data access request,
determining, by the router application, at least one data storage node from the plurality of distributed data storage nodes that can satisfy the data access request, and
transmitting, by the router application to the at least one data storage node, the data access request for fulfillment of the data access request on behalf of the service application.

17. The first computer node of claim 16, wherein the service application is executed within a service pod at the first computing node, the router application is executed within a router pod at the first computing node, and the data access request is communicated locally between the service pod and the router pod at the first computing node.

18. The first computer node of claim 17, wherein the at least one data storage node is remote to the first computing node, and the data access request is transmitted from the router pod to the at least one data storage node over a communications network.

19. The first computer node of claim 17, wherein the at least one data storage node is the first computing node, and the data access request is transmitted locally from the router pod to a pod comprising the at least one data storage node.

20. The first computer node of claim 16, wherein the one or more processors configured to perform operations for determining, by the router application, the at least one data storage node from the plurality of distributed data storage nodes that can satisfy the data access request further comprises the one or more processors configured to perform operations for:
determining, by an authorizer application executed within the router pod at the first computing node, whether the service is authorized to issue the data access request based on a key corresponding to service data that is the subject of the data access request;
in response to the determining that the service is authorized, determining, by the router application, the at least one data storage node from among the plurality of distributed data storage nodes using a deterministic selection process based on the key; and
initiating transmission, by the router application to the at least one data storage node, of the data access request.
